(19) United States
(12) Patent Application Publication
(10) Pub. No.: US 2004/0174860 A1
(43) Pub. Date: Sep. 9, 2004

(54) System and method for facilitating IP telephony applications

(76) Inventors: Timothy J. Van Hammond, Appleton, WI (US); John H. Ptacek, Appleton, WI (US); Jeffrey P. Lang, Menasha, WI (US)

Correspondence Address: MICHAEL P. MAZZA, LLC, 686 CRESCENT BLVD., GLEN ELYN, IL, 60137, US

(21) Appl. No.: 10/378,588

(22) Filed: Mar. 4, 2003

(51) Int. Cl. H04L 12/66

(52) U.S. Cl. 370/352

(57) ABSTRACT

A system and method enabling designers to create IP telephony applications without the need for the designers or IP telephone users to understand either the native data format used by the IP telephones or the programming language used to construct the IP telephony applications.

### REFERENCE TO A COMPUTER PROGRAM LISTING APPENDIX SUBMITTED ON COMPACT DISC

Applicants hereby incorporate by reference herein the material on the duplicate compact discs labeled “Copy 1” and “Copy 2” and accompanying the application. The files on these compact discs are identified as follows: C# source code files, assorted icons, various DLLs, and files necessary to create the current, preferred embodiment of telephony applications using Software in the Microsoft Visual Studio® programming environment.

### BACKGROUND OF THE INVENTION

The invention generally relates to computer software, and a system and method for using that software, useful for demonstrating, developing and deploying IP (Internet Protocol) telephony applications. More specifically, the invention provides easy to use Software for creating IP telephony screens displayed on IP telephones or appropriate IP telephone emulators. The Software is designed to allow designers to construct IP telephony applications without the need for the designers or end users to have any specific knowledge either of the programming language which the IP telephones use to display information (e.g., XML, ASCII, etc.), or of IP technology or IP infrastructure.

A principle benefit of an IP telephony system, in comparison with traditional phone systems, is to take advantage of converging networks. In the past, telephony and data networks were separate. This required the customer to acquire different skills sets to manage each network. Telephony systems have utilized proprietary programming for the switch, different from IP data networks. In the converged world, using IP protocol as the standard, both telephony and data are able to run on the same network. This reduces cost by eliminating the need for separate personnel to manage each network, allowing customer data personnel to manage both networks.

Existing IP telephony systems employ application servers to provide advanced functionality for IP telephones beyond dial tone (i.e., to provide additional applications for the phone). These application servers utilize XML documents or other means for displaying information on the phone. To take one example, Cisco's Call Manager® application functions as the application server for that IP telephony phone routing system. In the Cisco implementation, an IP telephone (such as shown in FIG. 3) displays data transmitted in an XML format, using CISCO XML phone objects. Constructing applications in such a system requires advanced technical proficiency in not only XML but also the use of Cisco's XML phone objects. As a result, the ability of sales and sales engineer personnel to quickly demonstrate applications to prospective customers may be severely limited. Other IP telephony vendors may use other products for their specific implementations, using other data formats such as HTML, ASCII text, a proprietary format, or other format, and the present invention is intended to encompass the use of such other formats, as well. Again, as to the Cisco example, the creation of these XML (or HTML or ASCII text, etc.) documents requires knowledge both of the eXtensible Markup Language (XML) as well as of the underlying IP telephony architecture.

Accordingly, it would be desirable to develop Software to create IP telephony applications that may be used by personnel not trained in a specific underlying application architecture or IP technology, enabling such personnel to quickly design, create, and publish applications for an IP telephony phone or emulator. (In a demonstration mode, an emulator may be used to simulate the final implementation of the application. The final end-point for the display of an application is the IP telephone.) It would also be desirable to develop software which leverages a simple Windows-based interface, allowing even non-technical sales personnel to create prototype applications that demonstrate the power of integrated IP telephony. Still further, it would be desirable to provide a design tool, useable with IP telephones or accompanying, third-party phone emulator software on a Windows PC, for example, which would permit sales personnel to design IP telephony applications with customers, viewing the results on-screen using IP telephones, in real-time if desired. IP telephony objects could then be generated and displayed as separate screens on the IP telephone to create a screen-by-screen presentation. Alternatively, a Call Manager® (or similar) environment may be set up so that the design tool may be used to develop screens for actual IP telephones.

### DEFINITION OF CLAIM TERMS

The following terms are used in the claims of the patent as filed and are intended to have their broadest meaning consistent with the requirements of law. Where alternative meanings are possible, the broadest meaning is intended. All words used in the claims are intended to be used in the normal, customary usage of grammar and the English language.

“Canvas” means the container (e.g., display screen visible to the Software designer or user) receiving (e.g., designer-dragged) icons and allowing IP telephony application designers to graphically design their application flow.

“Graphical user interface” means a visual display of data, such as on a display screen of a computer, PDA, or other device, that is manipulatable.

“Designer” means anyone who constructs an IP telephony application.

“User” means anyone who uses an IP telephone or IP emulator.

“IP” means Internet Protocol, the technical specification which controls the transfer of data along the Internet.

“IP telephone” means a telephone, with or without an associated visual display, that communicates with an IP telephony switch (e.g., Cisco Call Manager®) using Internet Protocol.

“IP telephone emulator” means an application that emulates how an IP telephone functions. The emulator may run on a personal computer or other device, and can be either custom developed or provided by the IP telephone vendor.

“IP telephony application” means an application that is developed for use on IP telephones. Applications may be static, where the screens remain the same between requests, or dynamic where the screens change with each request, or a combination of both. IP telephony applications may take advantage of voice, video or text display properties of the phone.

“IP telephony object” means the structure or composition of the native data format used by the IP telephone or IP telephone emulator to convey information to the end user.

“Native data format” or “data in a native format” means the data format utilized by an IP telephone or IP telephone emulator to display information on a visual display associated with the IP telephone or IP telephone emulator. The native data format can be used to display menus, text screens or images in manner defined by the vendor to support IP telephony applications.

“Software” means the application software of the present invention, which may used to generate dynamic IP telephony applications, in which IP telephone display screens utilize real-time data corresponding to user requests and/or static IP telephony applications in which such screens are not dynamic between user requests. Software is compatible with IP telephony infrastructure, and may provide a toolbox of IP telephony objects, a toolbar of common functionality, and a canvas for dragging and displaying icons. Software provides designers and users with the capability of generating IP telephony screens (e.g. menu, image, text, input, etc., screens) through a Graphical User Interface (GUI) without requiring knowledge of how the IP telephone conveys content to the designer or user.

“Toolbox” contains IP telephony objects that may be placed on the canvas and that have functionality associated with them based upon the IP telephony application server definitions.

### SUMMARY OF THE INVENTION

The objects mentioned above, as well as other objects, are solved by the present invention, which overcomes disadvantages of known prior art IP telephony systems, while providing new advantages not believed associated with such systems.

The present invention provides a design tool which invigorates the IP telephony sales process by allowing sales personnel or others to dynamically create display screens for IP telephones without the need for extensive coding (i.e., instructions in a high-level computer language which are then compiled to execute on a computer platform).

One preferred embodiment of the invention, a Software implementation, allows designers to construct IP telephony applications accessible and employable by users of IP telephones or IP telephone emulators. Software enables the designers to construct the IP telephony applications by manipulating IP telephony objects, such as on a graphical user interface, to create data in a native format used for display of information to the users of the IP telephones or the IP telephone emulators. The Software allows the designers to construct the IP telephony applications and the users to utilize them without the designers and users being required to understand either the native data format or programming language used to construct the IP telephony applications.

In a particularly preferred embodiment, one or more IP telephones may have a graphical user interface including a first visual display and keypad associated with them. The designer may construct an IP telephony application using a second visual display which may show, for example, flow diagrams facilitating construction of the IP telephony application. This second visual display may be associated with the designer's computer, network server, PDA or other machine or device.

The IP telephony objects manipulated by the designers may be represented by icons, and the second visual display may include a canvas for dragging and displaying the icons. In a particularly preferred embodiment, the second visual display includes a toolbox of the IP telephony objects represented by icons which may be linked together during design of the IP telephony applications, and the second visual displays also has a toolbar and/or menu command which permits the IP telephony objects to be saved and published. Preferably, the Software permits the IP telephone designer to manipulate the graphical user interface to selectively display the IP telephony objects on the canvas without utilizing the programming language.

IP telephony applications used with the present invention may be either: static, in which information on the first visual displays is not based on real-time data derived from requests made by the users; or dynamic, in which information on the first visual display is based on real-time data derived from requests made by the users; or a combination of both. Preferably, the Software allows the IP telephony user to dynamically select existing images in various formats and convert the images to a format necessary to allow the user to interpret the information on the first visual display; such format may be, but need not be limited to, industry-standard formats such as TIF, GIF, BMP, PNG and/or JPG.

The Software of the present invention may be designed to function on a Windows®-based platform, as well as on non-Windows®-based platforms.

The native data format may be of various forms, including but not limited to XML, HTML or ASCII text.

The Software of the present invention may interface with IP telephony objects derived from images originating from the Internet and/or from a file system of a computer in communication with one or more of the IP telephones. The Software also permits the designer to create IP telephony objects, as defined by an IP telephony vendor, in the native data format of the IP telephone derived from databases, network data stores, directory services and/or local file stores or network file stores which may include but are not limited to text files, spreadsheet files, or word processing files.

In an alternative embodiment, software enabling IP telephony applications to be developed from IP telephony objects is provided, which permits users of IP telephones or IP telephone emulators to access and employ the IP telephony applications. The Software enables the designers to construct the IP telephony applications by manipulating IP telephony objects to create machine-readable data utilized by IP telephones to convey information to the users. Neither the designers nor the users are required to understand the programming language in order to develop and use the IP telephony applications.

In yet another alternative embodiment, a method is provided which allows a designer to construct an IP telephony application accessible and employable by users of IP telephones or IP telephone emulators. A plurality of IP telephones or IP telephone emulators are provided, each having an associated first visual display. One or more designers having computers with a second visual display are also provided. The designer constructs the IP telephony application using Software enabling the designer to visually manipulate elements on a graphical user interface associated with the at least second visual display to create data in a native format used for display of information by the IP telephones to the users. The Software permits the designer to construct the IP telephony application, and the users to use an IP telephone or IP telephone emulator running the IP telephony application, without the need for either the designer or the users to understand either the native data format used by the IP telephone or IP telephone emulator or programming language used to construct the IP telephony application. The IP telephony applications thus constructed may be either static or dynamic, or a combination of both.

### BRIEF DESCRIPTION OF THE DRAWINGS

The novel features which are characteristic of the invention are set forth in the appended claims. The invention itself, however, together with further objects and attendant advantages thereof, will be best understood by reference to the following description taken in connection with the accompanying drawings, in which:

FIG. 1 is a schematic diagram of a network placement topology for a preferred embodiment of the present invention;

FIG. 2 is a use flow diagram for a preferred embodiment of the invention;

FIG. 3 is an exemplary visual display of an IP telephone using an embodiment of the invention;

FIG. 4 is an exemplary screen shot for a preferred embodiment of the invention in use;

FIG. 5 is an application map pertaining to a business demonstration of the invention referred to in the written specification; and

FIGS. 6-8 are high level diagrams representing Sofware application building blocks showing how these may be utilized in various ways.

### DETAILED DESCRIPTION OF THE PREFERRED EMBODIMENTS

Set forth below is a description of what are currently believed to be the preferred embodiments and/or best examples of the invention claimed. Future and present alternatives and modifications to these preferred embodiments are contemplated. Any alternatives or modifications which make insubstantial changes in function, in purpose, in structure or in result are intended to be covered by the claims of this patent.

In a preferred embodiment of the invention, the Software permits display of a toolbox of IP telephony IP telephony objects, a toolbar of common functionality, a canvas for dragging and displaying icons, and menu commands. While in the preferred embodiment the Software is designed to run on a Microsoft Windows®-based platform, it is contemplated that it may be run on platforms other than Windows® (e.g., Java®, Unix®, Linux®, AS/400, IBM Mainframe, etc.).

IP telephony applications permit data to be presented in different representations. Each of these representations, such as a menu, a text screen, an image, etc., is referred to here as an IP telephony object. IP telephony objects are defined by the IP telephone vendor to operate within their IP telephony architecture. For each IP telephony object type, there may exist one or more corresponding icons in the toolbox. These icons may be dragged (via a designer or end-user mouse operation or in another known manner), mouse-clicked or otherwise applied to the screen canvas. Designers or users may click on items on the canvas to supply the specific information for that IP telephony object necessary to create the IP telephony screen. Numerous icons may be placed on the canvas to create the dynamic flow of an application.

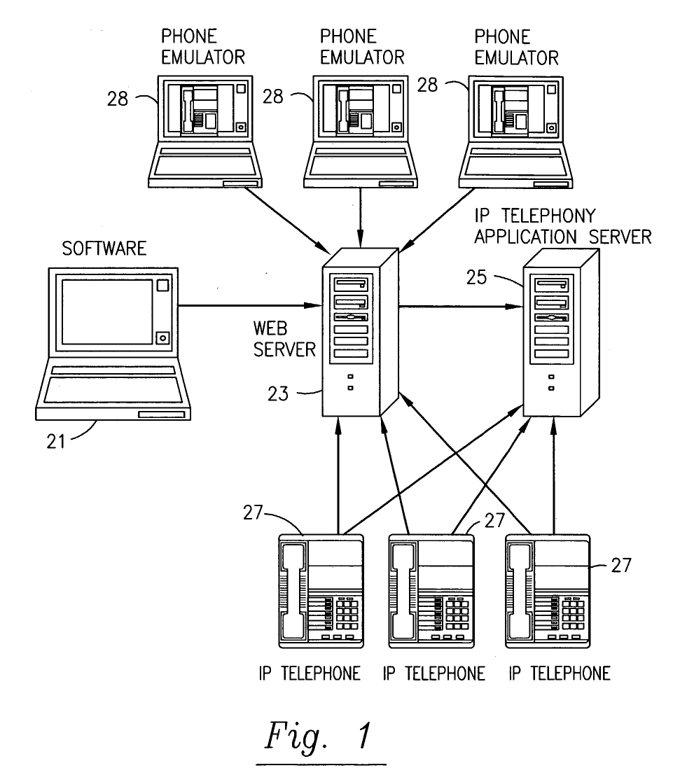

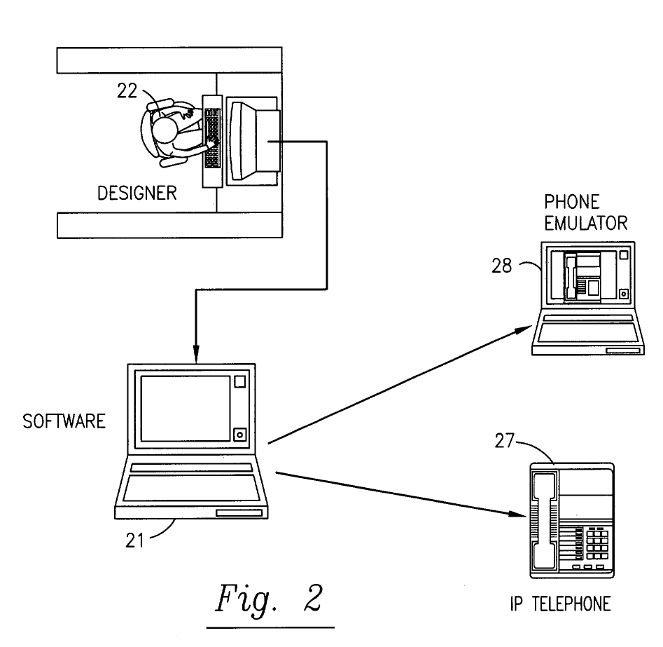

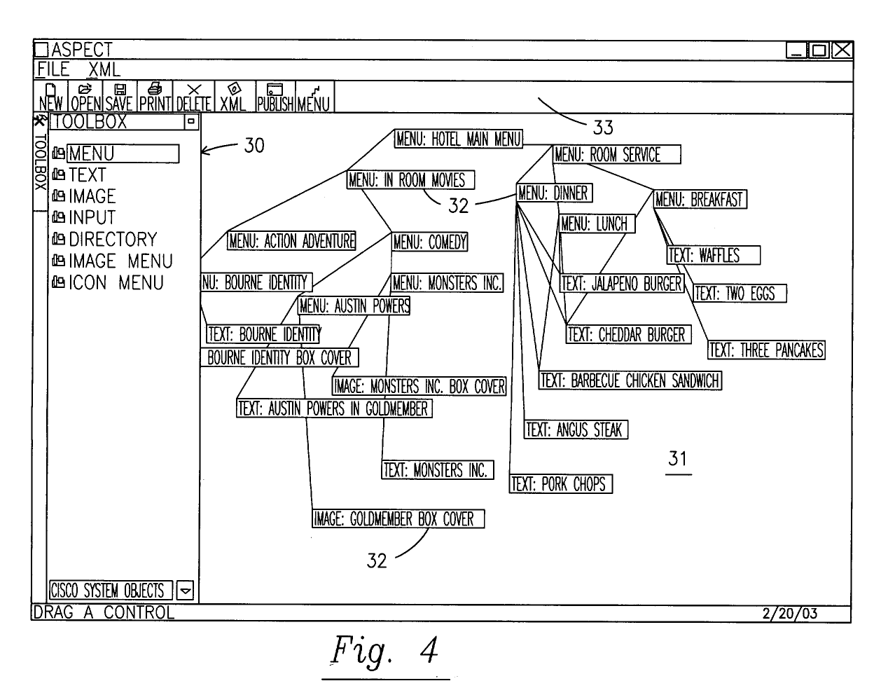

FIG. 4 shows one screen shot created by an IP telephony application designer 22 (see FIG. 2) using Software of the present invention, illustrating toolbox 30 with icons representing IP telephony objects 32 displayed on canvas 31, along with toolbar 33. IP telephone application designer 22 may view the resulting IP telephony object's native data format for any icon on the application canvas, which may be linked as shown. Each of these documents may be published or saved to a location for viewing with either a phone emulator 28 or an IP telephone 27 (FIG. 1).

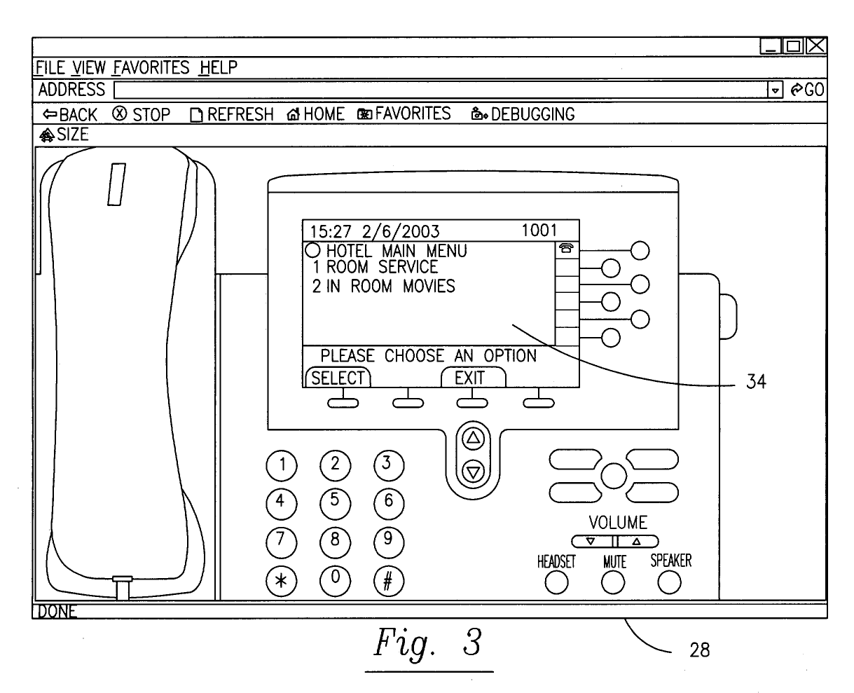

Referring now to FIG. 1, a preferred network topology placement for use with the present invention is shown, in which Software of the present invention may be running on a personal computer 21, for example. IP telephones 27 may access an intermediate server, such as an IP telephony application server 25, which provides a directory of information enabling access to web server 23. Web server 23 may be located anywhere on the Internet, or may be located within a specific network. Phone emulators 28 may also access web server 23, as shown. As one example, an application may be written to provide weather updates to the visual display 34 on a Chicago-located IP telephone (FIG. 3). The Software of the IP telephone may access application server 25, requesting weather in Chicago. Server 25 may then access a server, such as web server 23 (e.g. www.weather.com), to obtain this information.

As another example, Software may utilize an industry-standard Open DataBase Connectivity (ODBC), which permits a designer to construct an IP telephony application, using a front-end tool not requiring specific programming language knowledge, for accessing business systems (e.g., a computer-based accounting system). A designer or end-user may then use the toolbox associated with the Software to list icons providing access to databases, for example of an accounting system, to give (e.g.) accounting system functionality for participating IP telephones of that business. In this manner, the invention provides the ability to connect to virtually any database and develop screens for IP telephony systems. Alternatively, a designer or user may use the Software to list icons that allow connection to web services to develop such screens.

With this background, it will now be understood that when the IP telephone application designer hits the “publish” button, information entered on the Software screen (by filling in text boxes, for example) for display on an IP telephone will be converted by the Software to IP telephony phone objects, e.g., Cisco XML phone objects. The native format of these IP telephony objects may then be published to an application server, e.g., a web server that can serve files (e.g. XML), at a location which are accessible to either the emulator and/or the IP telephone.

Referring now to FIG. 2, a use flow diagram is shown, in which designer 22 communicates with personal computer 21 running Software, where computer 21 is resident on a network, for example. Software may be used to publish files accessible to phone emulator software 28 and/or an IP telephone 27. Designer 22 may also use the Software to publish files to a web server, and a user/client may then access the IP telephony application using an IP telephone.

Referring again to FIGS. 3-4, using Software of the present invention, a menu may be created and items linked to the menu. For example, visual display 34 of the IP telephone 27 of FIG. 3 shows a Hotel Main Menu offering room service and in-room movies. Using the telephone keypad, this menu may be accessed and, referring to FIG. 4, items/phone objects 32 linked to the menu may be dragged from toolbox 30 to canvas 31 to create the display shown in FIG. 4.

Still referring to FIGS. 3-4 for background, using the application Software of the present invention, an image desired to be displayed on an IP telephone or emulator may be created by following these steps. (The following is specific to a Cisco IP telephony implementation, but those of ordinary skill in the art will understand that other IP telephony implementations may be used following different, albeit similar, methods.) First, the image icon is located on the toolbar. Next, the icon may be dragged (or mouse-clicked) from the toolbar to the canvas. A window may then be displayed with the information required to create an image. In the “XML Name” box, the XML file name to be displayed may be entered. If desired, in the Title box a title may be entered for display on the XML phone (here, XML Phone refers to both an actual IP Telephone or the IP Telephone emulator). Also, if desired, in the Prompt box a prompt may be entered for display at the bottom of the XML phone display. In the LocationX and LocationY boxes, the X and Y locations of the Image on the phone display may be entered. In the Width, Height and Depth boxes, the corresponding width, height and depth may be entered, if necessary. In the Image box, an image may be provided for conversion and display on the phone. The designer or user may either browse the computer file system or provide the URL of an image on the Internet. Next, an indication may be made if the image is to be scaled to fit on the phone (in which case width or height do not need to be entered). Clicking “ok” closes the window.

To create a text screen that may ultimately be displayed on an IP Telephone or emulator, the following steps may be taken. First, the Text Icon may be located on the toolbar, and the icon may be dragged (or mouse-clicked) from the toolbar to the canvas. A window may then be displayed with the information required to create a text screen. In the XML Name box, the XML file name may be entered for displayed. If desired, in the Title box a title may be entered for display on the XML phone. Also if desired, in the Prompt box a prompt may be entered for display at the bottom of the XML phone display. In the Text box, the text information to be displayed on the phone may be entered. Clicking “ok” closes the window.

To create a menu screen that may ultimately be displayed on an IP Telephone or emulator, the following steps may be taken. First, the Menu Icon on the toolbar may be located, and may be dragged or mouse-clicked from the toolbar to the canvas. A window may display some of the information required for the Menu. In the XML Name box, the XML file name may be entered for display. If desired, in the Title box a title may be entered for display on the XML phone. Also if desired, in the Prompt box a prompt may be entered for display, as well. Next, the designer may connect existing elements on the canvas with the menu icon on the canvas to add the actual row to the menu. This may be done by: (1) clicking the Menu icon in the toolbar; (2) selecting the Menu icon on the canvas (dragged over or mouse-clicked from the toolbar); and (3) selecting the icon to be displayed on the menu. The title entered for the icon may be used for the menu item description. By double clicking the connecting line, this may be changed.

To view an icon's XML, the following steps may be taken. Select a control. Next, the XML icon on the toolbar may be located. The XML for the document will now appear. To publish the XML, the Publish button on the toolbar may be clicked.

By way of background concerning the image creation process, for an existing IP telephony application, images to be displayed on the IP telephone phone screen may be translated to a specific format for the IP telephone platform using vendor-developed or platform-developed Dynamic Link Libraries (DLLs). The Software allows the designer or end-user to dynamically select an image in many standard formats, such as TIF, GIF or JPG, and use the DLL to convey the image to the format necessary for display on the telephone. This may be accomplished by choosing an image from a local or networked file system or by providing a URL address. No knowledge of the image creation process is required.

In the preferred embodiment, the Software was created using the programming language C#. However, it will be understood by those of ordinary skill in the art that suitable Software may be created for varying applications using a variety of other languages, such as but not limited to Java®, Visual Basic, C++, Perl, PHP, Cobalt, Fortran, etc.

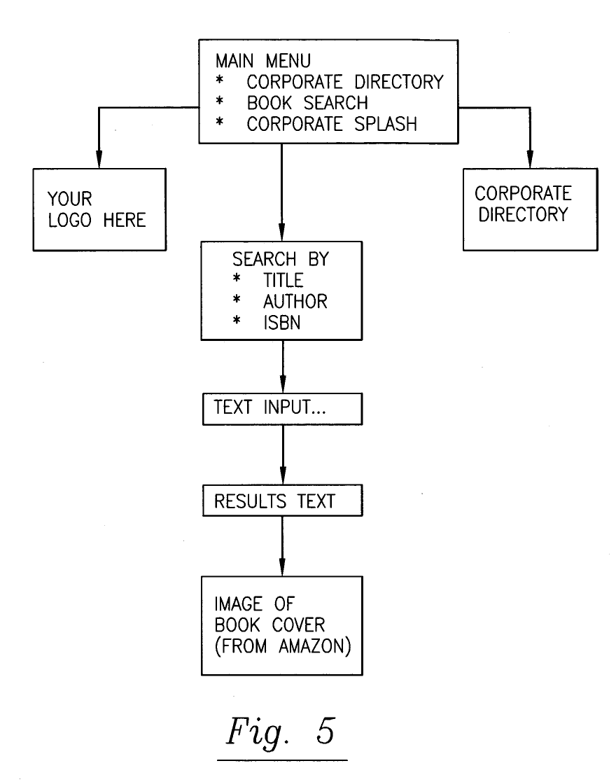

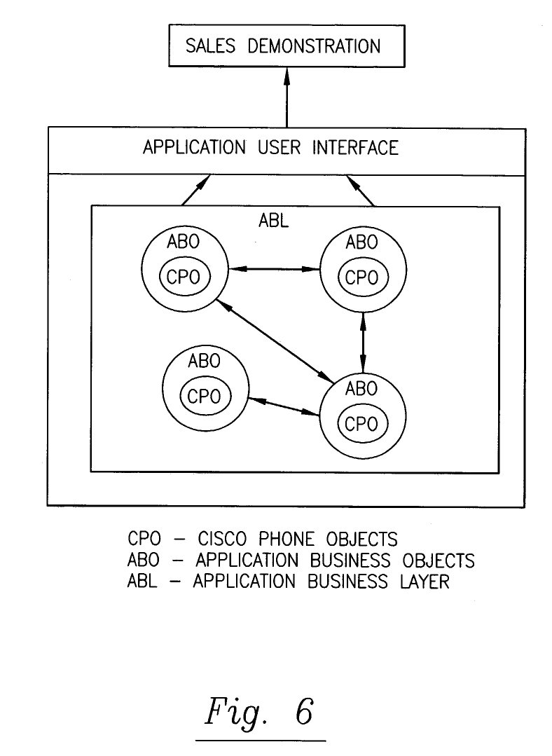

Referring now to FIGS. 5-8, to further appreciate the advantages of the invention an exemplary demonstration using the invention is discussed. In this example, a bookstore “CB” located near a college campus has a business strategy of meeting or beating Amazon.com's prices on any book sold. CB decides to use Cisco IP telephones to minimize the hardware and support costs associated with Personal Computer (PC). CB develops an easy to use IP telephony application to search Amazon.Com on behalf of CB's employees and customers. FIG. 5 shows an application flow diagram of an IP telephony application deployed to an IP telephone for “CB” employees and customers accessing IP telephones located at “CB” Bookstore. First, an IP telephone application designer (e.g., a CB Bookstore employee) creates a prototype of the application using Software of the invention. As shown in FIG. 6, (blue) Cisco phone objects (“CPOs”) may be “wrapped” into business objects (green) termed Application Business objects. These Application Business objects in total are referred to as the Application Business Layer that the Software user interface of the present invention relies upon. The use of such wrapped business objects dispenses with the designer's need to construct an IP telephony application in XML. Further, the Software allows creation of images corresponding to the vendor's (e.g., Cisco's) phone objects using information automatically pulled from the associated DLLs, whereas if images were generated from the vendor's phone objects, the designer would need to exercise judgment in obtaining specific information from the associated DLLs. In short, use of wrapped business objects provided by the Software of the present invention reduces complexity, increases standardization, and provides a migration path facilitating designer construction of IP telephony applications that are not based on vendor (e.g., Cisco)-specific phone object language.

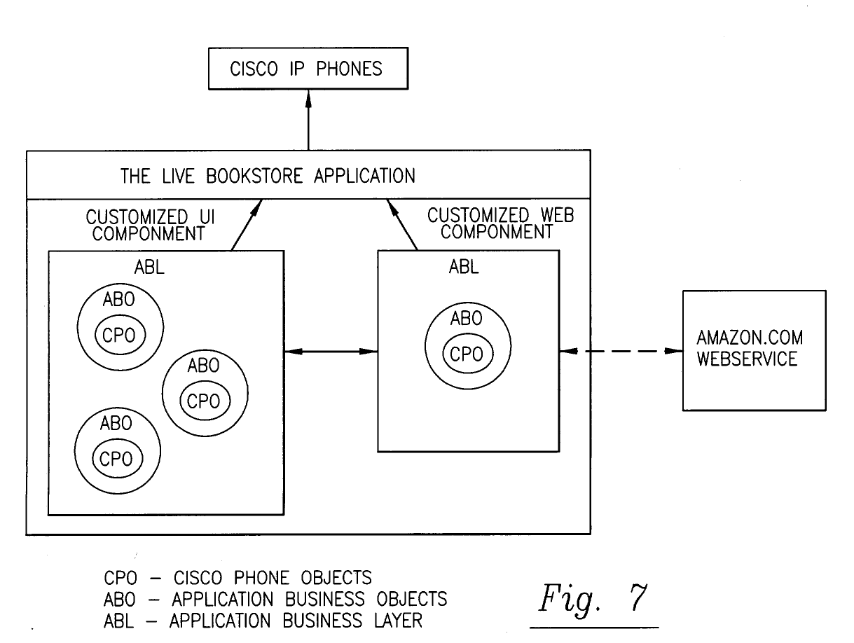

Referring to FIG. 7, the Application Business Layer may be used, independent of the Software, to create a dynamic application based on user requests (“LiveBookStoreApplication”). The LiveBookStore application may utilize the Application Business layer to create a customized UI component for displaying information on the IP Telephone. The UI component takes advantage of a customized web component which may then access the Amazon.com web service, and is usable by the (e.g.) Cisco IP telephones. This customized web component may be a vendor's own application, using building blocks provided by the Software, for a static IP telephony application.

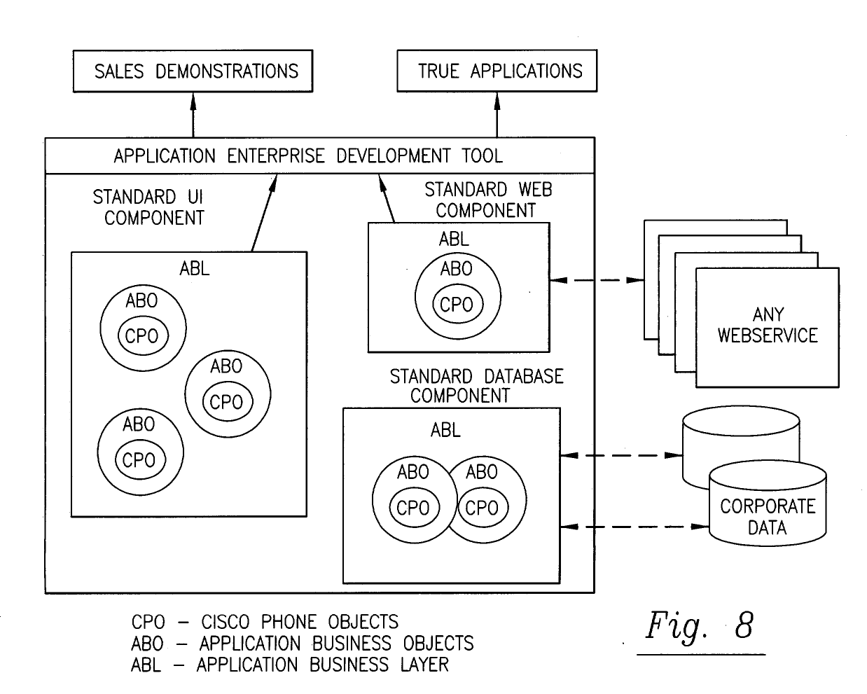

To create a dynamic IP telephony application, the Software can migrate from being merely a prototyping tool to actually constituting a development platform by building off of the Application Business Layer and creating new components which create IP telephony objects based upon user requests. Referring to FIG. 8, the creation of elaborate objects allows the provision of sophisticated features without requiring custom programming. Such features include web-service integration components, database integration components, and dynamic user interaction, as illustrated in FIG. 8.

It will now be appreciated that the Software of the present invention allows the designer to create text, menu, image, input or icon objects, in the native data format of the IP telephone or IP telephone emulator, that are derived from one or more of the following: a database; files from a local file stores (e.g., text files, spreadsheet files such as Excel® or Lotus®, word processing files such as MS Word® or Word Perfect®, or images files such as PNG, GIF, BMP, TIFF and/or JPG, etc.); network data stores; files from network file stores (e.g., text files, spreadsheet files such as Excel® or Lotus®, word processing files such as MS Word® or Word Perfect®, or images files such as PNG, GIF, BMP, TIFF and/or JPG, etc.); files from Internet resources (e.g., text files, spreadsheet files such as Excel® or Lotus®, word processing files such as MS Word® or Word Perfect®, or images files such as PNG, GIF, BMP, TIFF and/or JPG, etc); directory services (e.g., Microsoft's Active Directory, Novell Directory Services or LDAP); third party applications, such as the Enterprise Resource Planning (ERP) system; Customer Relationship Management Systems (CRM); or Internet resources or web services. Similarly, image objects, image menu objects and/or icon menu objects may be created in real time from data collection services (e.g., PLCs).

Given the foregoing description, various advantages of the present invention will now be appreciated. Thus, the invention provides an application designer with the ability to construct IP telephony applications that are easy to use, since no intricate knowledge of IP telephony objects is required. This is also true because standard interfaces may be used with the present invention, such as Microsoft Windows® interfaces utilizing drag-and-drop functionality, pull-down menus, pop-up property sheets, and HTML browsers or other implementations of graphical user interfaces (GUIs). One-step application publishing to the emulator may also be provided.

The above description is not intended to limit the meaning of the words used in the following claims that define the invention. For example, it be understood that other embodiments not specifically mentioned here that accomplish the same general principles and advantages as set forth here may do so in insubstantially different ways, while still falling within the principles of the present invention. Thus, it is contemplated that future modifications in function or result exist that are not substantial changes and that all such insubstantial changes in what is claimed are intended to be covered by the claims.

We claim:

1. A Software implementation allowing designers to construct IP telephony applications accessible and employable by users of IP telephones or IP telephone emulators, comprising:
Software enabling the designers to construct the IP telephony applications by manipulating IP telephony objects on a graphical user interface to create data in a native format used for display of information to the users of the IP telephones or the IP telephone emulators, wherein the designers and the users are not required to understand either the native data format or programming language used to construct the IP telephony applications.

2. The Software implementation of claim 1, wherein each of a plurality of IP telephones has an associated first visual display.

3. The Software implementation of claim 2, wherein the designer constructs the IP telephony application using a second visual display.

4. The Software implementation of claim 3, wherein the second visual display is associated with a computer of the designer.

5. The Software implementation of claim 3, wherein the second visual display is associated with a network server.

6. The Software implementation of claim 2, wherein one or more of the IP telephony applications are dynamic, in which information on the first visual display is based on real-time data derived from requests made by the users.

7. The Software implementation of claim 2, wherein one or more of the IP telephony applications are static, in which information on the first visual displays is not based on real-time data derived from requests made by the users.

8. The Software implementation of claim 3, wherein the second visual display comprises flow diagrams facilitating construction by the designers of the IP telephony applications.

9. The Software implementation of claim 3, wherein the IP telephony objects are represented by icons, and the second visual display comprises a canvas for dragging and displaying the icons.

10. The Software implementation of claim 9, wherein one or more of the IP telephones includes a graphical user interface comprising a keypad and the first visual display.

11. The Software implementation of claim 10, wherein the Software permits the IP telephone designer to manipulate the graphical user interface to selectively display the IP telephony objects on the canvas without utilizing the programming language.

12. The Software implementation of claim 3, wherein the second visual display includes a toolbox of the IP telephony objects represented by icons which may be linked together during design of the IP telephony applications, and the second visual displays also provide a toolbar which permits the IP telephony objects to be saved and published.

13. The Software implementation of claim 3, wherein the second visual display includes a toolbox of the IP telephony objects represented by icons which may be linked together during design of the IP telephony applications, and the second visual displays also provide a menu command which permits the IP telephony objects to be saved and published.

14. The Software implementation of claim 3, wherein the Software functions on a Windows®-based platform.

15. The Software implementation of claim 3, wherein the Software functions on a non-Windows®-based platform.

16. The Software implementation of claim 1, wherein the native data format is one of the following: XML, HTML or ASCII text.

17. The Software implementation of claim 9, wherein the IP telephony objects are derived from images originating from the Internet and/or from a file system of a computer in communication with one or more of the IP telephones.

18. The Software implementation of claim 17, wherein the Software allows the IP telephone user to dynamically select existing images in various formats and convert the images to a format necessary to allow the user to interpret the information on the first visual display.

19. The Software implementation of claim 18, wherein the formats comprise industry-standard formats such as TIF, GIF, BMP, PNG and/or JPG.

20. The Software implementation of claim 1, wherein the Software allows the designer to create IP telephony objects, as defined by an IP telephony vendor, in the native data format of the IP telephone derived from a local file store.

21. The Software implementation of claim 20, wherein the local file store comprises one or more of the following: text files; spreadsheet files; or word processing files.

22. The Software implementation of claim 1, wherein the Software allows the designer to create IP telephony objects, as defined by an IP Telephony vendor, in the native data format of the IP telephone derived from a network file store.

23. The Software implementation of claim 22, wherein the network file store comprises one or more of the following: text files; spreadsheet files; or word processing files.

24. The Software implementation of claim 1, wherein the Software allows the designer to create IP telephony objects, as defined by an IP telephony vendor, in the native data format of the IP telephone derived from a database.

25. The Software implementation of claim 1, wherein the Software allows the designer to create IP telephony objects, as defined by an IP Telephony vendor, in the native data format of the IP telephone derived from a network data store.

26. The Software implementation of claim 1, wherein the Software allows the designer to create IP telephony objects, as defined by an IP Telephony vendor, in the native data format of the IP telephone derived from directory services.

27. Software enabling IP telephony applications to be developed from IP telephony objects, permitting users of IP telephones or IP telephone emulators to access and employ the IP telephony applications, comprising:
Software enabling the designers to construct the IP telephony applications by manipulating IP telephony objects to create machine-readable data utilized by IP telephones to convey information to the users, wherein the designers and the users are not required to understand the programming language in order to develop and use the IP telephony applications.

28. A method allowing a designer to construct an IP telephony application accessible and employable by users of IP telephones or IP telephone emulators, comprising the steps of:
providing a plurality of the IP telephones or IP telephone emulators with an associated first visual display;
providing the designer with one or more computers having at least a second visual display;
the designer constructing the IP telephony application using Software enabling the designer to visually manipulate elements on a graphical user interface associated with the at least second visual display to create data in a native format used for display of information by the IP telephones to the users;
wherein use of the Software permits the designer to construct the IP telephony application and the users to use an IP telephone or IP telephone emulator running the IP telephony application without the need for either the designer or the users to understand either the native data format used by the IP telephone or IP telephone emulator or programming language used to construct the IP telephony application.

29. The method of claim 28, wherein the Software permits use of an IP telephony application which is dynamic, such that information on the first visual display is based on real-time data derived from requests made by the users.
